(19) United States
(12) Patent Application Publication
(10) Pub. No.: US 2012/0147793 A1
(43) Pub. Date: Jun. 14, 2012

(54) System and Method for the Coexistence of Multiple Communications Systems

(75) Inventors: Bin Chen, Schaumburg, IL (US); Huiru He, Shenzhen (CN)

(73) Assignee: FutureWei Technologies, Inc., Plano, TX (US)

(21) Appl. No.: 13/315,852

(22) Filed: Dec. 9, 2011

Related U.S. Application Data
(60) Provisional application No. 61/421,503, filed on Dec. 9, 2010.

(51) Int. Cl. H04W 4/00; H04J 3/00; H04W 84/02

(52) U.S. Cl. 370/280; 370/328; 370/338

(57) ABSTRACT

A method for enabling a coexistence of multiple communications systems includes locating a gap in a first frame structure of a first communications protocol used in a first communications system, and shifting a second frame structure of a second communications protocol used in a second communications system into alignment with the gap to inhibit interference between simultaneous transmissions of the first communications system and the second communications system. The method also includes transmitting the shifted second frame structure to a communications device in the second communications system.

This application claims the benefit of U.S. Provisional Application No. 61/421,503, filed on Dec. 9, 2010, entitled “Method and System for Utilizing Location Information in a Wireless System,” which application is hereby incorporated herein by reference.

### TECHNICAL FIELD

The present invention relates generally to digital communications, and more particularly to a system and method for the coexistence of multiple communications systems.

### BACKGROUND

Worldwide Interoperability for Microwave Access (WiMAX) is a telecommunications technical standard that provides fixed and fully mobile Internet access. The current WiMAX revision provides up to 40 Mbit/s with an IEEE 802.16m update expected to offer up to 1 Gbit/s fixed speeds.

The Third Generation Partnership Project (3GPP) Long Term Evolution (LTE) is a technical standard in the mobile network technology tree that produced the Global System for Mobile Communications/Enhanced Data-rates for Global Evolution (GSM/EDGE) and Universal Mobile Telecommunications System/High Speed Packet Access (UMTS/HSxPA) network technologies. It is a project of 3GPP, operating under a name trademarked by one of the associations within the partnership, the European Telecommunications Standards Institute.

WiMAX is based on the IEEE 802.16 series standards, which provide wireless broadband access service. 3GPP LTE and LTE-Advanced are also standards providing wireless broadband access service. IEEE 802.16m and 3GPP LTE-Advanced are all International Mobile Telecommunications Advanced (IMT-Advanced) candidate standards, and their basic physical technologies are similar, say, Multiple Input Multiple Output (MIMO) and Orthogonal Frequency Division Multiple Access (OFDMA), but some detailed technologies are different, especially in channel and signaling. The differences in signaling often lead to coexistence problems when both communications systems are transmitting.

### SUMMARY OF THE INVENTION

Example embodiments of the present invention which provide a system and method for the coexistence of multiple communications systems.

In accordance with an example embodiment of the present invention, a method for enabling a coexistence of multiple communications systems is provided. The method includes locating a gap in a first frame structure of a first communications protocol used in a first communications system, and shifting a second frame structure of a second communications protocol used in a second communications system into alignment with the gap to inhibit interference between simultaneous transmissions of the first communications system and the second communications system. The method also includes transmitting the shifted second frame structure to a communications device in the second communications system.

In accordance with another example embodiment of the present invention, a method for enabling a coexistence of multiple communications systems is provided. The method includes locating a first conflict region in a first frame structure of a first communications protocol used in a first communications system and a second conflict region in a second frame structure of a second communications protocol used in a second communications system, where a first simultaneous transmission by the first communications system in the first conflict region and a second simultaneous transmission by the second communications system in the second conflict region result in interference. The method also includes puncturing a subset of the first conflict region in the first frame structure, thereby producing a punctured first frame structure, and transmitting the punctured first frame structure to a communications device in the first communications system.

In accordance with another example embodiment of the present invention, a device is provided. The device includes a processor, and a transmitter coupled to the processor. The processor locates a gap in a first frame structure of a first communications protocol used in a first communications system, and shifts a second frame structure of a second communications protocol used in a second communications system into alignment with the gap to inhibit interference between simultaneous transmissions of the first communications system and the second communications system. The transmitter transmits the shifted second frame structure to a communications device in the second communications system.

One advantage of an embodiment is that multiple communications systems with incompatible frame structures can coexist without causing significant interference to one another. Additionally, coexistence can be achieved without severely impacting the performance of the multiple communications systems.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example communications system deployment according to example embodiments described herein;

FIG. 2a illustrates an example frame structure of a WiMAX communications system;

FIG. 2b illustrates an example frame structure of a 3GPP LTE TDD communications system with a Type 2 configuration;

FIG. 3 illustrates an example frame of a WiMAX communications system and a frame of a 3GPP LTE TDD communications system simultaneously transmitted according to example embodiments described herein;

FIG. 4a illustrates an example flow diagram of operations in enabling communications systems to coexist without significant interference according to example embodiments described herein;

FIG. 4b illustrates an example flow diagram of operations of a first example embodiment in enabling communications systems to coexist without significant interference according to example embodiments described herein;

FIG. 4c illustrates an example flow diagram of operations of a second example embodiment in enabling communications systems to coexist without significant interference according to example embodiments described herein;

FIG. 5 illustrates an example flow diagram of operations in communicating in a communications system that is coexisting with another communications system according to example embodiments described herein;

FIG. 6 illustrates an example diagram of a frame structure of a WiMAX communications system and a frame structure of a 3GPP LTE TDD communications system according to example embodiments described herein;

FIG. 7 illustrates an example diagram of a frame structure of a WiMAX communications system and a frame structure of a 3GPP LTE TDD communications system, with a shift in frame structure according to example embodiments described herein;

FIG. 8 illustrates an example diagram of a frame structure of a WiMAX communications system and a frame structure of a 3GPP LTE TDD communications system with a shift of more than 20 μs in frame structure to align frame structure with TTG according to example embodiments described herein;

FIG. 9 illustrates an example diagram of a frame structure of a WiMAX communications system and a frame structure of a 3GPP LTE TDD communications system with an alternate special subframe in the frame structure of the 3GPP LTE TDD communications system according to example embodiments described herein;

FIG. 10 illustrates an example diagram of a frame structure of a WiMAX communications system and a frame structure of a 3GPP LTE TDD communications system with a portion of a 3GPP LTE TDD UL subframe punctured according to example embodiments described herein;

FIG. 11 illustrates an example diagram of a frame structure of a WiMAX communications system and a frame structure of a 3GPP LTE TDD communications system with a portion of a 3GPP LTE TDD UL subframe punctured and with an alternate special subframe in the frame structure of the 3GPP LTE TDD communications system according to example embodiments described herein;

FIG. 12 illustrates an example diagram of a frame structure of a WiMAX communications system and a frame structure of a 3GPP LTE TDD communications system with a portion of a special subframe punctured according to example embodiments described herein;

FIG. 13 illustrates an example diagram of a frame structure of a WiMAX communications system and a frame structure of a 3GPP LTE TDD communications system with a portion of a special subframe punctured and with an alternate special subframe configuration in the frame structure of the 3GPP LTE TDD communications system according to example embodiments described herein;

FIG. 14 illustrates an example diagram of a frame structure of a WiMAX communications system and a frame structure of a 3GPP LTE TDD communications system with a portion of a special subframe punctured according to example embodiments described herein;

FIG. 15 illustrates an example diagram of a frame structure of a WiMAX communications system and a frame structure of a 3GPP LTE TDD communications system with a portion of a special subframe punctured and with an alternate special subframe configuration in the frame structure of the 3GPP LTE TDD communications system according to example embodiments described herein;

FIG. 16 illustrates an example diagram of a frame structure of a WiMAX communications system and a frame structure of a 3GPP LTE TDD communications system with a portion of a UL subframe being punctured according to example embodiments described herein;

FIG. 17 illustrates an example diagram of a frame structure of a WiMAX communications system and a frame structure of a 3GPP LTE TDD communications system with a portion of a UL subframe being punctured and an alternate special subframe structure according to example embodiments described herein;

FIG. 18 illustrates an example diagram of a frame structure of a WiMAX communications system and a frame structure of a 3GPP LTE TDD communications system with a portion of frame structure being punctured and the frame structure of the 3GPP LTE TDD communications system is shifted according to example embodiments described herein;

FIG. 19 illustrates an example diagram of a frame structure of a WiMAX communications system and a frame structure of a 3GPP LTE TDD communications system with a portion of frame structure being punctured and the frame structure of the 3GPP LTE TDD communications system is shifted according to example embodiments described herein;

FIG. 20 illustrates an example diagram of a frame structure of a WiMAX communications system and a frame structure of a 3GPP LTE TDD communications system with a portion of frame structure being punctured and the frame structure of the 3GPP LTE TDD communications system is shifted according to example embodiments described herein; and

FIG. 21 illustrates an example communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present invention provides many applicable inventive concepts that can be embodied in a wide variety of specific contexts. The specific embodiments discussed are merely illustrative of specific structures of the invention and ways to operate the invention, and do not limit the scope of the invention.

One embodiment of the invention relates to modifying a frame structure of a communications system to allow for two communications systems to coexist while simultaneously transmitting. For example, the frame structure of a first communications system is time shifted so that the frame structure of the two communications systems are aligned or closely aligned to minimize interference between the two communications systems. As another example, a portion of the frame structure of the first communications system is punctured (in other words, not used for transmitting and receiving) to minimize interference between the two communications systems. As a further example, a portion of the frame structure of the first communications system is flipped from UL to DL or from DL to UL as permitted to minimize interference between the two communications systems. As yet another example, the frame structure of the first communications system is shifted, a portion of its frame structure is punctured, a portion is flipped, or a combination thereof, to minimize interference between the two communications systems.

The present invention will be described with respect to example embodiments in a specific context, namely a 3GPP LTE Time Domain Duplexed (TDD) communications system operating in close proximity to a WiMAX communications system. The invention may also be applied, however, to other groupings of communications systems with incompatible frame structures operating in close proximity that would otherwise cause a significant amount of interference with one another, potentially disrupting operation in all of the communications systems within the grouping.

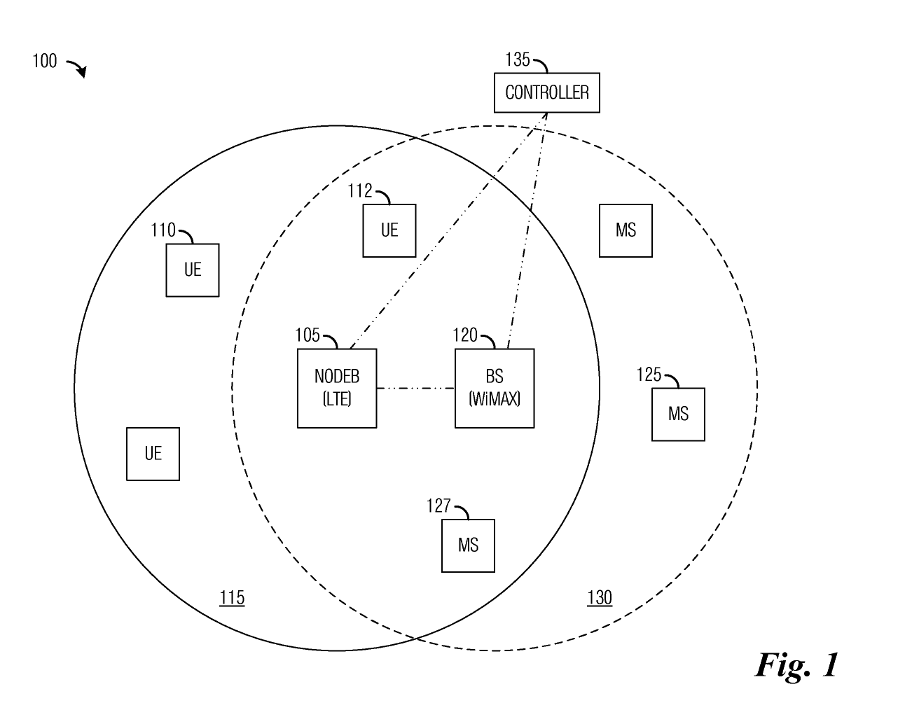

FIG. 1 illustrates a communications system deployment 100. Communications system deployment 100 includes a 3GPP LTE TDD communications system and a WiMAX communications system. The 3GPP LTE TDD communications system includes a NodeB 105 (which is also commonly referred to as an evolved NodeB (eNB), a communications controller, and the like) and a plurality of User Equipment (UE), such as UE 110 and UE 112, operating within coverage area 115, shown as a solid circle. The WiMAX communications system includes a Base Station (BS) 120 and a plurality of Mobile Stations (MS), such as MS 125 and MS 127, operating within coverage area 130, shown as a dashed circle. Generally, a NodeB and a BS may also be commonly referred to as communications controllers, controllers, and the like. Furthermore, a UE and a MS may also be commonly referred to as mobiles, users, subscribers, terminals, and the like.

As shown in FIG. 1, NodeB 105 and BS 120 are deployed as separate physical entities located some distance apart. Alternatively, NodeB 105 and BS 120 may be co-located in a single physical entity or they may be two separate physical entities deployed in a single location, effectively forming a single physical entity.

While it is understood that communications systems may employ multiple NodeBs capable of communicating with a number of UEs and multiple BSs capable of communicating with a number of MSs, only one NodeB, one BS, three UEs, and three MSs are illustrated for simplicity.

Since NodeB 105 and BS 120 are located closely to one another, their coverage areas (coverage area 115 and coverage area 130) overlap. Therefore, transmissions from NodeB 105 may cause interference with BS 120 and transmissions from BS 120 may cause interference with NodeB 105. As an example, considering UE 112 that is operating within the coverage area overlap of NodeB 105 and BS 120, then transmissions from BS 120 may interfere with transmissions from NodeB 105. Similarly, transmissions from NodeB 105 interfere with transmissions from BS 120 for MS 127. Although there are UEs and MSs that are not operating in the coverage area overlap, transmissions intended for these UEs and MSs may still be interfered by transmissions from the other communications system.

NodeB 105 and BS 120 may be coupled together to share information, as well as coordinate to allow for the coexistence of their respective communications systems. A controller 135 may also be coupled to NodeB 105 and BS 120. Controller 135 allows for the sharing of information if there is no direct linkage between NodeB 105 and BS 120. Controller 135 also coordinates between NodeB 105 and BS 120 to allow for the communications systems to coexist.

As an example, NodeB 105 and BS 120 coordinate and make changes to their respective communications systems to allow the two communications systems to coexist. Alternatively, controller 135 makes changes to the respective communications systems of NodeB 105 and BS 120 to allow the two communications systems to coexist.

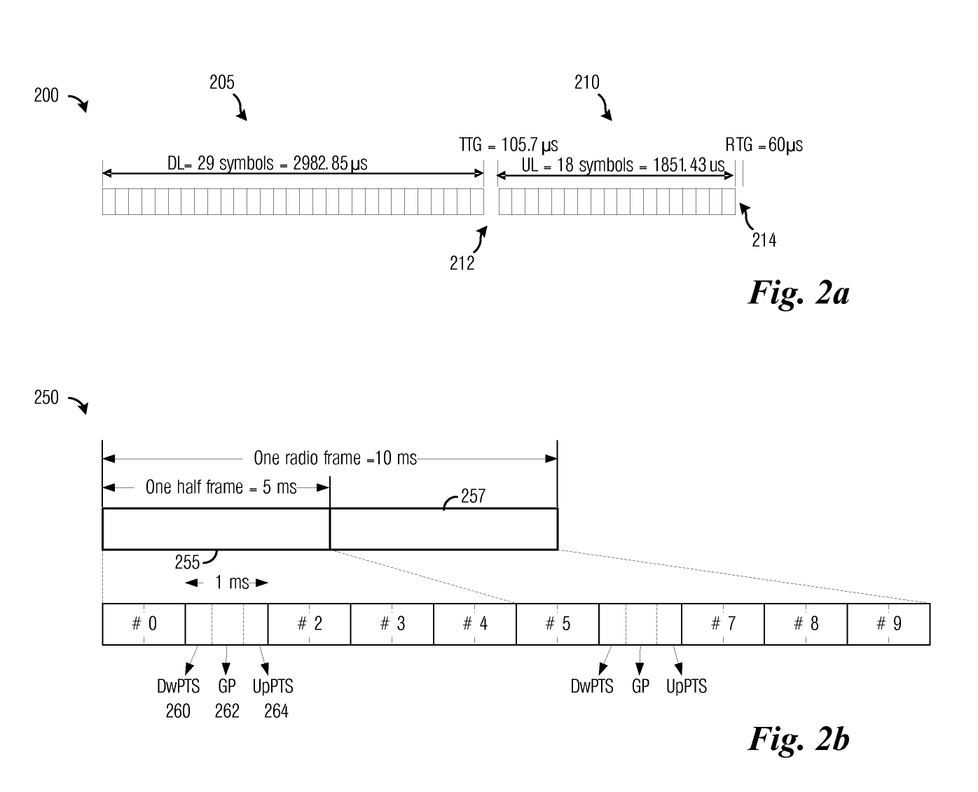

FIG. 2a illustrates a frame structure 200 of a WiMAX communications system. WiMAX Certified equipment that is commercially deployed today uses a 5 ms TDD frame structure. This frame structure has a downlink (DL) subframe 205 and an uplink (UL) subframe 210. DL subframe 205 is separated from UL subframe 210 by a Transmit Transition Gap (TTG) 212 (according to the WiMAX standards, TTG=0.105714 ms) which allows time for the radios to switch from DL to UL. A Receive Transition Gap (RTG) 214 (according to the WiMAX standards, RTG=0.06 ms) separates UL subframe 210 from a subsequent DL subframe and allows time for the radios to switch from UL to DL. Overall there are 47 symbols in a WiMAX frame and a DL to UL ratio (DL:UL) of symbols may be configured as shown in Table 1.

TABLE 1
WiMAX DL/UL Configurations.

| | |
|---|---|
| Downlink | Uplink |

| Symbols | Duration (ms) | Symbols | Duration (ms) |
|---|---|---|---|
| 35 | 3.6 | 12 | 1.234286 |
| 34 | 3.497143 | 13 | 1.337143 |
| 33 | 3.394286 | 14 | 1.44 |
| 32 | 3.291429 | 15 | 1.542857 |
| 31 | 3.188571 | 16 | 1.645714 |
| 30 | 3.085714 | 17 | 1.748571 |
| 29 | 2.982857 | 18 | 1.851429 |
| 28 | 2.88 | 19 | 1.954286 |
| 27 | 2.777143 | 20 | 2.057143 |
| 26 | 2.674286 | 21 | 2.16 |

FIG. 2b illustrates a frame structure 250 of a 3GPP LTE TDD communications system with a Type 2 configuration. 3GPP LTE TDD supports a 10 ms TDD radio frame structure composed of ten 1-ms subframes. Each 10 ms TD-LTE frame includes two half-frames of 5 ms each, first half frame 255 and second half frame 257. Switching points can occur with 5 ms and 10 ms periodicities.

Each half-frame (e.g., first half frame 255) consists of eight slots of length 0.5 ms and a special subframe consisting of three special fields: Downlink Pilot TimeSlot (DwPTS), Guard Period (GP), and Uplink Pilot TimeSlot (UpPTS) (e.g., DwPTS 260, GP 262, and UpPTS 264 in first half frame 255). The GP allows time for the radios to switch from DL to UL. The lengths of DwPTS and UpPTS are configurable subject to a total length of DwPTS, GP and UpPTS being equal to 1 ms. In all configurations with 5 ms switch-point periodicity, subframes 1 and 6 are special subframes. Other Subframes are assigned for either DL or UL transmission. LTE supported UL-DL Allocations are shown in Table 2.

TABLE 2
1-TD-LTE DL/UL Configurations.

| UL/DL | Period | Subframe | | | | | | | | | |
|---|---|---|---|---|---|---|---|---|---|---|---|
| Configuration | (mS) | 0 | 1 | 2 | 3 | 4 | 5 | 6 | 7 | 8 | 9 |
| 0 | 5 | DL | S | UL | UL | UL | DL | S | UL | UL | UL |
| 1 | | DL | S | UL | UL | DL | DL | S | UL | UL | DL |
| 2 | | DL | S | UL | UL | DL | DL | S | UL | DL | DL |
| 3 | 10 | DL | S | UL | UL | UL | DL | DL | DL | DL | DL |
| 4 | | DL | S | UL | UL | DL | DL | DL | DL | DL | DL |
| 5 | | DL | S | UL | UL | DL | DL | DL | DL | DL | DL |
| 6 | 5 | DL | S | UL | UL | UL | DL | S | UL | UL | DL |

Also, Table 3 shows the supported special subframe configurations.

TABLE 3
Supported special subframe configurations.

| | Normal cyclic prefix in downlink | | | Extended cyclic prefix in downlink | | |
|---|---|---|---|---|---|---|
| | | UpPTS | | | UpPTS | |
| Special | | Normal cyclic | Extended cyclic | | Normal cyclic | Extended cyclic |
| subframe | | prefix | prefix | | prefix | prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

The designs of both WiMAX and 3GPP LTE TDD communications systems include adjustable configuration settings which are selected by the system operator. The adjustable configuration settings include a time period allocated to DL transmission, a time period allocated to UL transmission, and guard periods. Interference between the communications systems is minimized by ensuring the appropriate time-alignment between a WiMAX frame and a 3GPP LTE TDD frame is such that neither communications system transmits its TDD DL subframe while the other system is transmitting its TDD UL subframe. This can be achieved by synchronizing in time the frame structure of the WiMAX and 3GPP LTE TDD communications systems, along with using appropriate configurations.

Mobile systems, most notably WiMAX/IEEE 802.16 and 3GPP LTE TDD (or TD-LTE), use a Time Division Duplex (TDD) mode to divide UL and DL transmissions. When they coexist with each other at the same location, they will interfere with each other since their frame structure is not same and there is overlapping between their DL and UL. In this case, when one communications system is transmitting, the other communications system is receiving, the transmitting communications system causes interference to receiving communications system. When the two communications systems are running in one infrastructure, and share the same radio filter, the transmitting communications system will block receiving communications system.

When a WiMAX communications system has a radio frame structure expressible as a DL:UL ratio of 29:18 (therefore the DL subframe has 29 symbols and the UL symbol has 18 symbols), the WiMAX communications system cannot coexist with the 3GPP LTE TDD communications system without significant interference since their frame structure does not align.

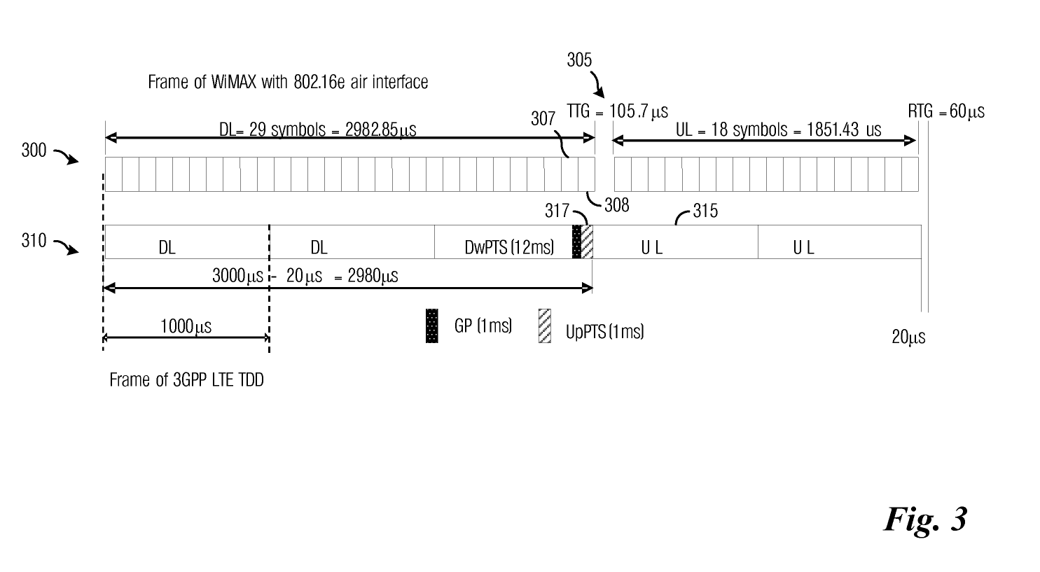

FIG. 3 illustrates a frame 300 of a WiMAX communications system and a frame 310 of a 3GPP LTE TDD communications system simultaneously transmitted. As shown in FIG. 3, TTG 305 of frame 300 overlaps with a UL sub-frame 315 of frame 310, while UpPTS 317 of frame 310 overlaps DL symbols 307 and 308 of frame 300. Therefore, there is a significant amount of interference when the WiMAX communications system and the 3GPP LTE TDD communications system are coexisting. It is noted that frame 310 (of the 3GPP LTE TDD communications system) starts 1000 micro seconds (or equivalently, us or μs) later than frame 300 (of the WiMAX communications system).

According to an example embodiment, it is possible to alter (e.g., through shifting, puncturing, flipping, and the like) the frame structure of one or both of the communications system so that the two communications systems can coexist without causing significant interference when both communications systems are simultaneously transmitting. The altering of the frame structure of one or both of the communications systems may be based on aligning TTG 305 of frame 300 with UpPTS 317 or some other special field in frame 310, such as GP or DwPTS. Although the discussion presented herein focuses on two communications systems, the example embodiments are operable with any number of communications systems, such as two, three, four, and the like. Similarly, the discussion presented herein focuses on a particular WiMAX frame configuration with a DL:UL ratio of 29:18. However, the example embodiments are operable with any DL:UL ratio. Therefore, the discussion of two communications systems and the DL:UL ratio of 29:18 should not be construed as being limiting to either the scope or the spirit of the example embodiments.

Considering as an example, the frame structure of a WiMAX communications system and the frame structure of a 3GPP LTE TDD communications system may be aligned at a DL/UL division. In the WiMAX communications system, the DL/UL division is referred to as the TTG, while in the 3GPP LTE TDD communications system, the DL/UL division is referred to as the GP (although DwPTS or UpPTS may also be used). Alignment of DL transmissions helps to avoid interference of 3GPP LTE TDD DL transmissions to WiMAX UL transmissions, as well as avoid interference of WiMAX UL transmissions to 3GPP LTE TDD DL transmissions. According to an example embodiment, an end point of a 3GPP LTE TDD DL subframe along with a propagation delay may be aligned so that it is ahead of (i.e., leads) a mid point of the TTG of the WiMAX frame.

Similarly, alignment of UL transmissions helps to avoid interference of 3GPP LTE TDD UL transmissions to WiMAX DL transmissions, as well as avoid interference of WiMAX DL transmissions to 3GPP LTE UL transmissions. According to an example embodiment, a start point of a 3GPP LTE TDD UL subframe minus a propagation delay may be aligned so that it is behind (i.e., trails) a mid point of the TTG of the WiMAX frame.

Table 4 illustrates an example division of frame structures to permit a coexistence of a WiMAX communications system and a 3GPP LTE TDD communications system.

TABLE 4
Example DL/UL Division of WiMAX and 3GPP LTE TDD frame structures.

| | 3GPP | Special | Maximum | 3GPP LTE TDD | |
|---|---|---|---|---|---|
| | LTE | Subframe of | Coverage | Extra Overhead | |
| WiMAX | TDD | 3GPP LTE | (based on | (based on | Frame Offset |
| DL/UL | DL/UL | TDD | minimum(GP, | maximum | (3GPP LTE |
| Division | Division | (Dw:GP:Up) | TTG)) | coverage) | TDD) |
| 35:12 | 3:1 | 9:3:2 (Conf 6) | ~7 km | ~3% | 2 ms |
| 34:13 | 3:1 | 3:9:2 (Conf 5) | ~12 km | ~10% | 2 ms |
| 33:14 | 3:1 | 3:9:2 (Conf 5) | ~12 km | ~10% | 2 ms |
| 32:15 | 3:1 | 3:9:2 (Conf 5) | ~12 km | ~10% | 2 ms |
| 31:16 | 3:1 | 3:9:2 (Conf 5) | ~9 km | ~11% | 2 ms |
| 30:17 | Not applicable | | | | |
| 29:18 | Not applicable | | | | |
| 28:19 | 2:2 | 12:1:1 (Conf 4) | ~3 km | 0% | 1 ms |
| 27:20 | 2:2 | 10:3:1 (Conf 2) | ~12 km | ~2% | 1 ms |
| 26:21 | 2:2 | 9:3:2 (Conf 4) | ~12 km | ~2% | 1 ms |

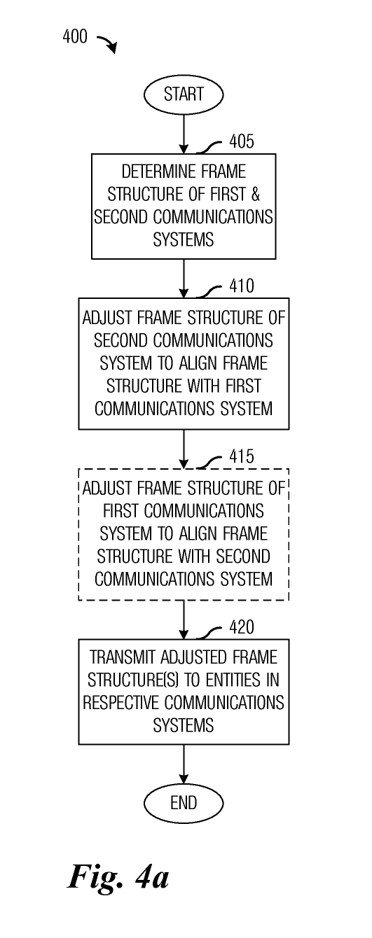

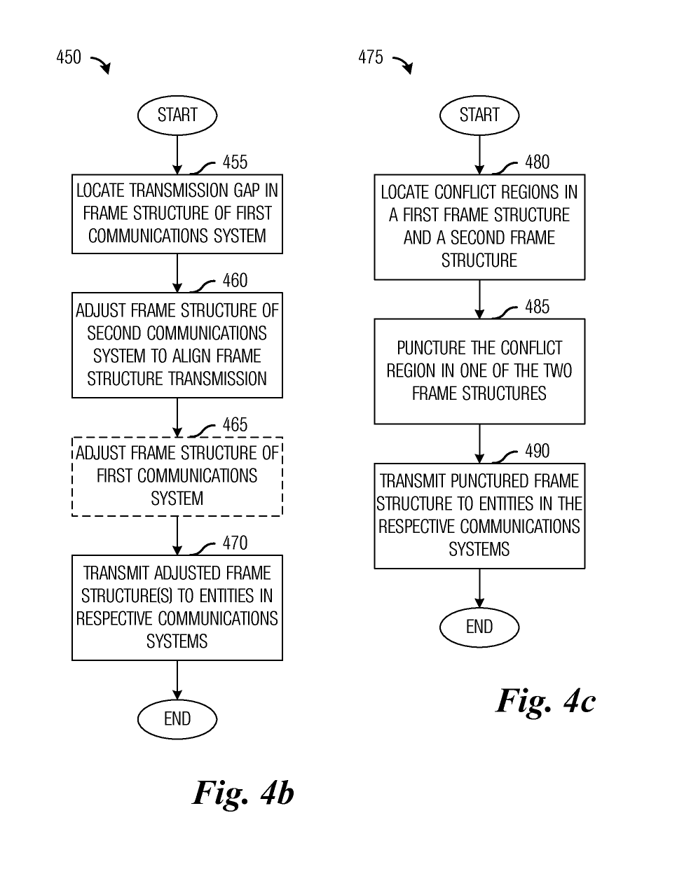

FIG. 4a illustrates a flow diagram of operations 400 in enabling communications systems to coexist without significant interference. Operations 400 may be indicative of operations occurring in a controller (such as controller 135), a communications controller (such as NodeB 105 and/or BS 120), or both, to make changes to a communications system(s) to allow multiple communications systems to coexist without significant interference.

Operations 400 may begin with the controller (or the communications controller) determining a frame structure of a first communications network, e.g., a WiMAX communications network, and a second communications network, e.g., a 3GPP LTE TDD communications network (block 405). According to an example embodiment, the controller (or the communications controller) determines the frame structure of the communications networks based on configuration information about the communications networks provided by an operator of the communications network or by detecting configuration information exchanged by entities in the communications networks.

The controller (or the communications controller) may adjust the frame structure of the second communications system to align the frame structure of the second communications system with the frame structure of the first communications system (block 410). According to an example embodiment, the alignment of the frame structures of the two communications systems is set so that the interference between the two communications systems is minimized.

According to an example embodiment, the controller (or the communications controller) may shift the frame structure of the second communications system, puncture portions of the frame structure of the second communications system, or shift and puncture the frame structure of the second communications system to align the two frame structures.

According to another example embodiment, if permitted, the controller (or the communications controller) may switch portions of the frame structure of a communications system from UL to DL or from DL to UL to align the two frame structures.

If the controller (or the communications controller) is permitted to adjust the frame structure of the first communications system to help align the frame structures of the two communications systems, then the controller may optionally adjust the frame structure of the first communications system (block 415). Reasons for the controller (or the communications controller) not being able to adjust the frame structure of the first communications system include: the first communications system has a rigid frame structure that does not allow for adjusting the frame structure; the first communications system has a flexible frame structure, but the adjustment that the controller (or the communications controller) wishes to perform is not permitted; adjusting the frame structure of the first communications system would result in some legacy communications devices unable to communicate with the first communications system, and the like.

With the frame structure of the second communications system (and potentially the frame structure of the first communications system) adjusted to align the frame structures of the two communications systems, the frame structures that been adjusted may be transmitted to entities in respective communications systems (block 420). As an example, if the frame structure of only the second communications system was adjusted, then only the frame structure of the second communications system needs to be transmitted to entities in the second communications system. If the frame structure of both communications systems were adjusted, then the frame structures of both the first communications system and the second communications system need to be transmitted to entities in the first communications system and the second communications system, respectively.

According to an example embodiment, the adjusting of the frame structures can be performed a priori and the changes to the frame structures can be stored during system deployment for transmitting to entities as they enter the respective communications systems. In such a scenario, the changes to the frame structures can be stored in a memory and retrieved when needed.

According to an example embodiment, the adjusting of the frame structure can be performed dynamically, for example, at specified times, periodically, when it is noticed that the performance of a communications system drops below a performance threshold, when another communications system comes online, and the like. In such a scenario, the adjusting of the frame structures is performed dynamically and the changes subsequently transmitted to entities in the respective communications systems. Additionally, the changes are stored in a memory and transmitted to entities as they enter the respective communications systems.

FIG. 4b illustrates a flow diagram of operations 450 of a first example embodiment in enabling communications systems to coexist without significant interference. Operations 450 may be an example embodiment of operations 400 of FIG. 4a. Operations 450 may be indicative of operations occurring in a controller (such as controller 135), a communications controller (such as NodeB 105 and/or BS 120), or both, to make changes to a communications system(s) to allow multiple communications systems to coexist without significant interference.

Operations 450 may begin with a location of a transmission gap in a frame structure used in a first communications system (block 455). For discussion purposes, considering a situation wherein the first communications system is a WiMAX compliant communications system with a frame structure as shown as frame structure 300 in FIG. 3. The transmission gap located in the frame structure may be TTG 305.

With the transmission gap located, a frame structure of a second communications system may be adjusted to align the frame structures of the two communications systems to inhibit interference between the two communications systems when both communications systems are transmitting (block 460). For discussion purposes, considering a situation wherein the second communications system is a 3GPP LTE TDD compliant communications system with a frame structure as shown as frame structure 310 in FIG. 3. Adjustments to the frame structure of the second communications system may include shifts, e.g., time shifts, to the frame structure of the second communications system, puncturing a portion of the frame structure of the second communications system, flipping a portion of the frame structure of the second communications system, or a combination thereof.

The frame structure of the first communications system may optionally be adjusted to inhibit interference between the two communications systems when both communications systems are transmitting (block 465). As an example, adjustments to the frame structure of the first communications system may include shifts, e.g., time shifts, to the frame structure of the first communications system, puncturing a portion of the frame structure of the first communications system, flipping a portion of the frame structure of the first communications system, or a combination thereof.

With the frame structure of the second communications system (and potentially the frame structure of the first communications system) adjusted to align the frame structures of the two communications systems to the transmission gap of the frame structure of the first communications system, the frame structures that has been adjusted may be transmitted to entities in respective communications systems (block 470). As an example, if the frame structure of only the second communications system was adjusted, then only the frame structure of the second communications system needs to be transmitted to entities in the second communications system. If the frame structure of both communications systems were adjusted, then the frame structures of both the first communications system and the second communications system need to be transmitted to entities in the first communications system and the second communications system, respectively.

FIG. 4c illustrates a flow diagram of operations 475 of a second example embodiment in enabling communications systems to coexist without significant interference. Operations 475 may be an example embodiment of operations 400 of FIG. 4a. Operations 475 may be indicative of operations occurring in a controller (such as controller 135), a communications controller (such as NodeB 105 and/or BS 120), or both, to make changes to a communications system(s) to allow multiple communications systems to coexist without significant interference.

Operations 475 may begin with a location of a first conflict region in a frame structure used in a first communications system and a second conflict region in a frame structure used in a second communications system (block 480). The first conflict region and the second conflict region correspond to portions of the frame structures of the first communications system and the second communications systems wherein simultaneous transmissions by the first communications system in the first conflict region and by the second communications system in the second conflict region result in interference.

A subset of one of the conflict regions (either the first conflict region or the second conflict region or both the first conflict region and the second conflict region) may be punctured (or muted) (block 485). As an example, if a subset of the first conflict region is punctured, then transmissions typically do not occur in the first communications system in the subset of the first conflict region. According to an example embodiment, some forms of transmissions may still be allowed to occur, such as low powered transmissions or the transmission of reference signals.

The frame structure of the communications system with the punctured conflict region (either the frame structure of the first communications system or the frame structure of the second communications system or both) may be transmitted to entities in the respective communications system (block 490).

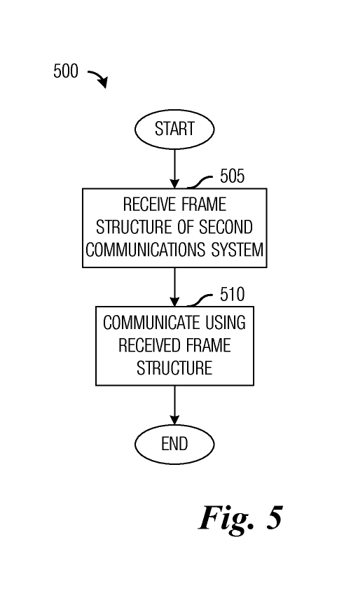

FIG. 5 illustrates a flow diagram of operations 500 in communicating in a communications system that is coexisting with another communications system. Operations 500 may be indicative of operations occurring in a UE, such as UE 112, or a BS, such as BS 127, that is operating in a first communications system that is coexisting with a second communications system.

Operations 500 may begin with a user, such as the UE or the BS, receiving a frame structure of its communications system (block 505). According to an example embodiment, the user receives information about the frame structure, such as its DL and UL configuration, frame numbers, frame intervals, shifts, offsets, punctured frames and/or symbols, and the like. The information about the frame structure may be sent to the user in its raw form or an indication of the frame structure may be sent to the user. For example, a bitmap may be used to indicate which frames or subframes are used for DL or UL, while another bitmap may be used to indicate which frames or subframes or symbols have been punctured. Additionally, a numerical value may be used to indicate a shift or an offset. The user may use the frame structure to communicate (block 510). As an example, using the frame structure, the user knows when to perform detection to find information about a resource allocation that allows it to send or receive a transmission.

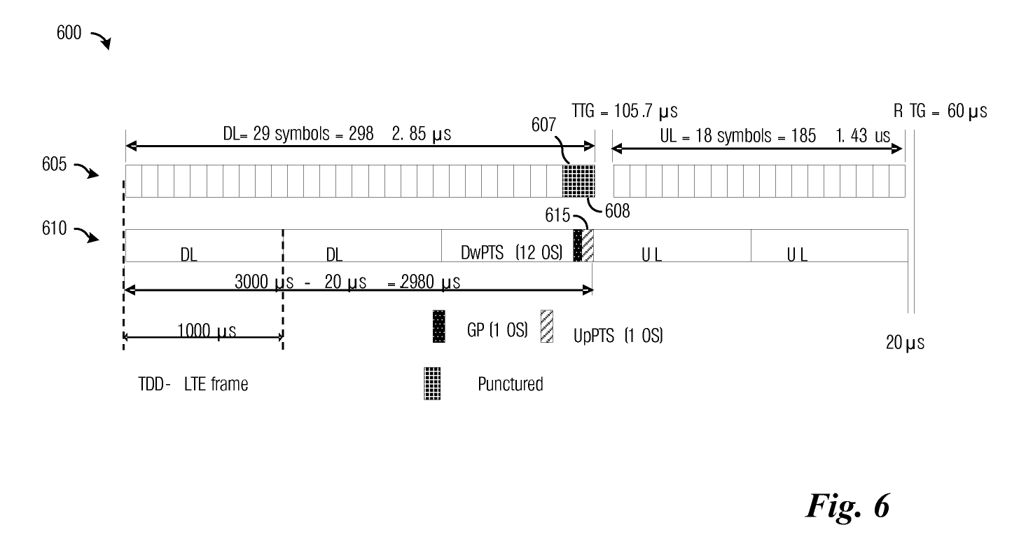

FIG. 6 illustrates a diagram 600 of a frame structure 605 of a WiMAX communications system and a frame structure 610 of a 3GPP LTE TDD communications system. As shown in FIG. 6, with the starting points of frame structure 605 and frame structure 610 lined up, UpPTS 615 of frame structure 615 overlaps with slots 607 and 608 of frame structure 605, it is possible to avoid interference by puncturing slots 607 and 608 of frame structure 605. Duration of DwPTS, GP, and UpPTS are shown as a ratio of Orthogonal Frequency Division Multiplex (OFDM) Symbols (OS), e.g., 12:1:1). It is noted that other ratio of OSs are possible.

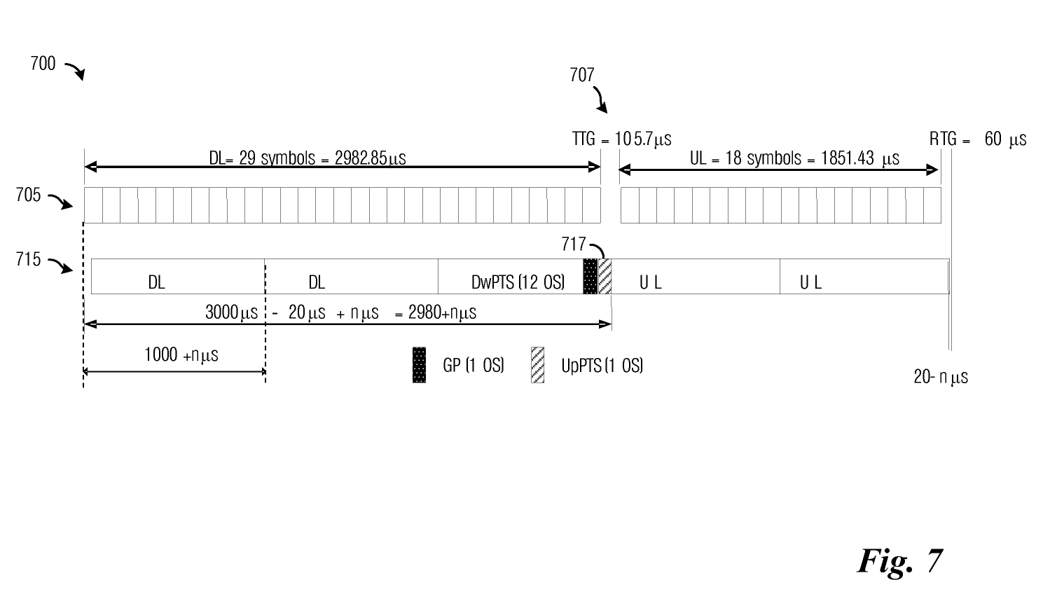

FIG. 7 illustrates a diagram 700 of a frame structure 705 of a WiMAX communications system and a frame structure 715 of a 3GPP LTE TDD communications system, with a shift in frame structure 715. It is possible to shift the frame structure of a 3GPP LTE TDD communications system to align it with TTG 707 of the frame structure of a WiMAX communications system, so that UpPTS 717 no longer overlaps with a portion of the WiMAX DL subframe. According to an example embodiment, the shift to the frame structure of the 3GPP LTE TDD communications system is a shift backward in time, which may also be viewed as a shift to frame structure 705 of the WiMAX communications forward in time. The shift in the frame structure of the 3GPP LTE TDD communications system is expressible as n μs, where n is a real number value. As an example, n ranges from 2.85 to 20. The value 2.85 is a difference in a length of a WiMAX DL subframe (e.g., 29 symbols or 2982.85 μs) compared to a 3GPP LTE TDD DL subframe plus the special subframe (e.g., 3000 μs−20 μs), while 20 μs a defined value that represents a blank duration between successive frames in the 3GPP LTE TDD standards and can therefore change if the standards are changed. Hence, if the lengths of the WiMAX DL subframe and/or the 3GPP LTE TDD DL subframe change, the range of n also changes accordingly.

In order to maintain silence during TTG 707, UpPTS 717 is punctured. It is noted that as shown in FIG. 7, the 3GPP LTE frame starts 1000+n μs later than the WiMAX frame. Therefore, it is possible to achieve a duration of [(2980+n)−2982.85]=(n−2.85) μs for TTG.

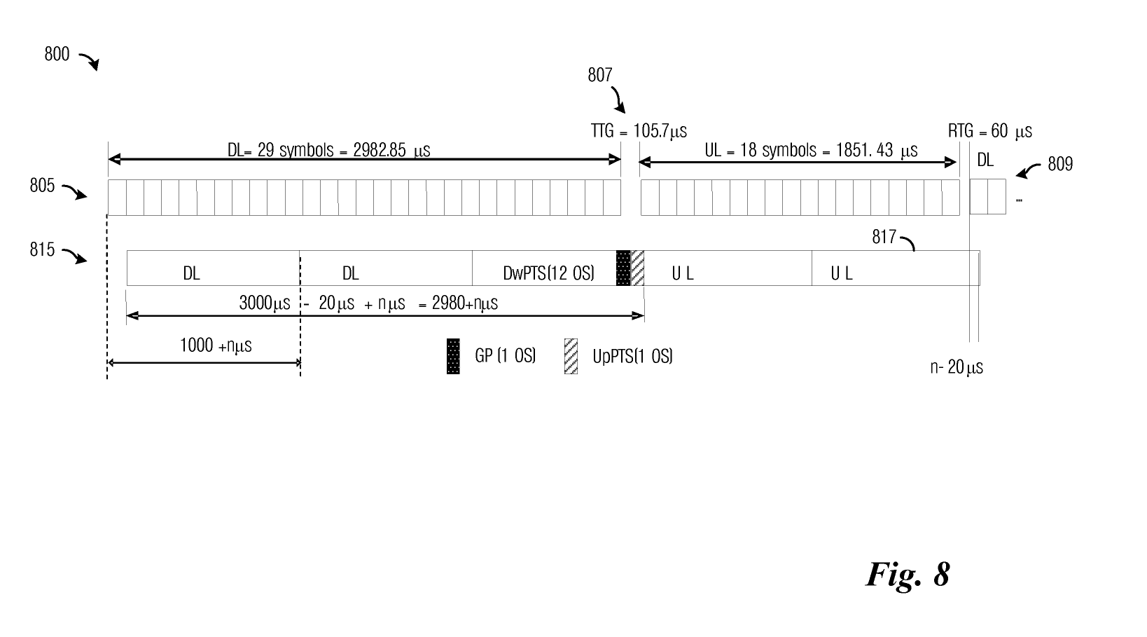

FIG. 8 illustrates a diagram 800 of a frame structure 805 of a WiMAX communications system and a frame structure 815 of a 3GPP LTE TDD communications system with a shift of more than 20 μs in frame structure 815 to align frame structure 815 with TTG 807. If n is increased, then a larger value of TTG is achievable (TTG is equal to (n−2.85) μs) therefore, a larger cell coverage area is supported. It is noted that cell coverage area is proportional to TTG. However, if n is larger than 20 μs, a UL subframe 817 of frame structure 815 overlaps into a subsequent frame 809 of the WiMAX communications system, thereby causing interference to both communications system in the overlapping portion (n−20 μs). However, interference to the DL portion of subsequent frame 807 may be reduced by having the WiMAX communications system transmitting at greater a power level in the overlapping portion.

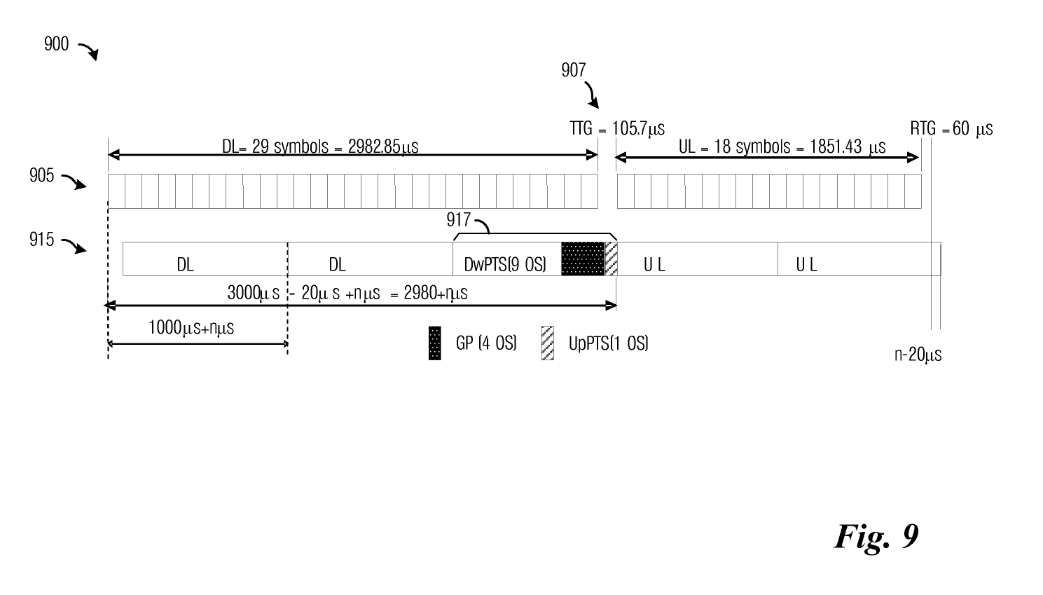

FIG. 9 illustrates a diagram 900 of a frame structure 905 of a WiMAX communications system and a frame structure 915 of a 3GPP LTE TDD communications system with an alternate special subframe in frame structure 915. It is noted that frame structure 915 is shifted to align with TTG 907. As shown in FIG. 9, an alternate special subframe 917 is used to reduce interference to the WiMAX communications system. As an example, special subframe 917 has fields DwPTS, GP, and UpPTS of duration 9 OS, 4 OS, and 1 OS, respectively. Clearly, other special subframe configurations are possible, depending on n, the amount of the shift.

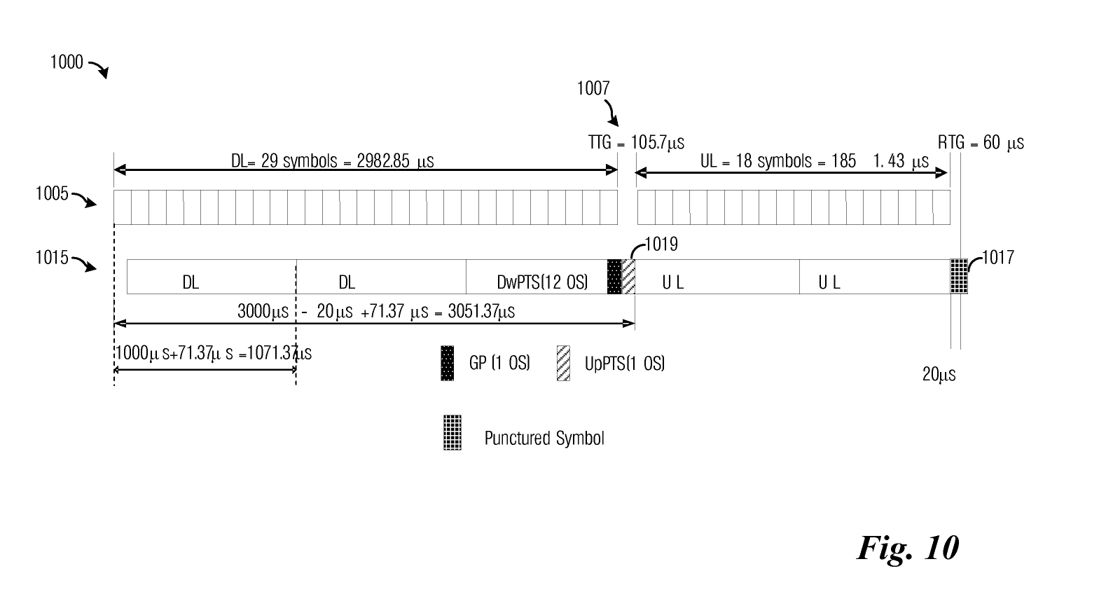

FIG. 10 illustrates a diagram 1000 of a frame structure 1005 of a WiMAX communications system and a frame structure 1015 of a 3GPP LTE TDD communications system with a portion of a 3GPP LTE TDD UL subframe punctured. Although frame structure 1015 is aligned with TTG 1007 of frame structure 1005, some interference remains. It is possible to puncture a portion of a frame of a communications system to avoid causing interference with another communications system. As an example, frame structure 1015 is shifted a number of m μs backwards in time, where m is a real number value, such as a single 3GPP LTE TDD subframe duration and a single 3GPP LTE TDD symbol duration or 1071.37 μs. Alternatively, the shift may also be viewed as a shift to frame structure 905 of the WiMAX communications forward in time. However, such a large shift (greater than 20 μs) results in a portion of a 3GPP LTE TDD UL subframe overlapping with a subsequent WiMAX frame. Therefore, to prevent interference, a portion of the 3GPP LTE TDD UL subframe is punctured (shown in FIG. 10 as punctured symbol 1017). It is noted that UpPTS 1019 is also punctured. Utilizing adjustment technique illustrated in FIG. 10, a 3GPP LTE TDD UE uses a shortened Physical Uplink Control Channel format of 1, 1a, or 1b for transmission of Hybrid Automatic Repeat Requested (HARQ) acknowledgements and Scheduling Requests (SR).

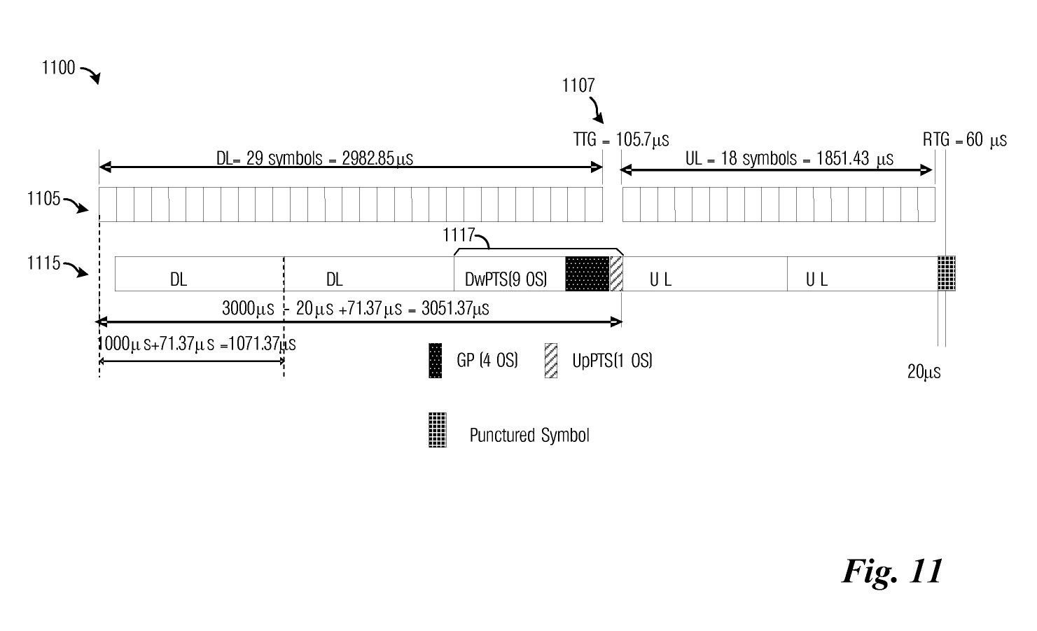

FIG. 11 illustrates a diagram 1100 of a frame structure 1105 of a WiMAX communications system and a frame structure 1115 of a 3GPP LTE TDD communications system with a portion of a 3GPP LTE TDD UL subframe punctured and with an alternate special subframe in frame structure 1115. It is noted that frame structure 1115 is shifted to align with TTG 1107. As shown in FIG. 11, an alternate special subframe 1117 is used to reduce interference to the WiMAX communications system. As an example, special subframe 1117 has fields DwPTS, GP, and UpPTS of duration 9 OS, 4 OS, and 1 OS, respectively. Clearly, other special subframe configurations are possible, depending on m, the amount of the shift.

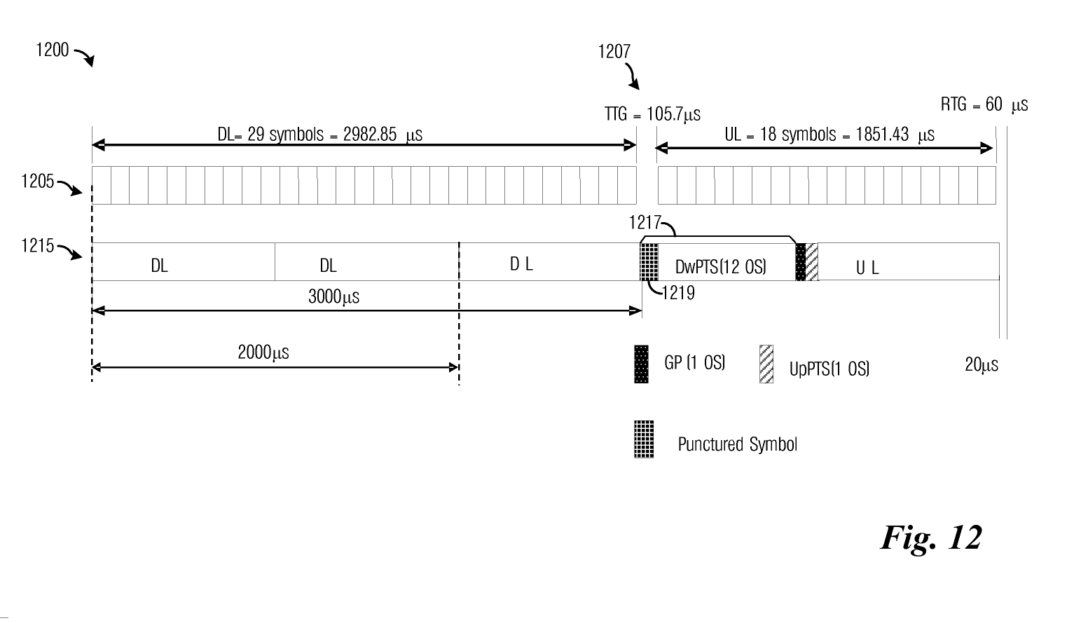

FIG. 12 illustrates a diagram 1200 of a frame structure 1205 of a WiMAX communications system and a frame structure 1215 of a 3GPP LTE TDD communications system with a portion of a special subframe punctured. Utilizing a shift that is equal to 2 3GPP LTE TDD subframe durations (i.e., 2000 μs), a different 3GPP LTE TDD frame configuration is used to align frame structure 1200 with TTG 1207. The use of the different 3GPP LTE TDD frame configuration allows a puncturing of a portion of a DwPTS 1217 of the special subframe, shown as portion 1219. Depending on configuration of the special subframe, the punctured portion of DwPTS 1217 may include the entirety of DwPTS 1217.

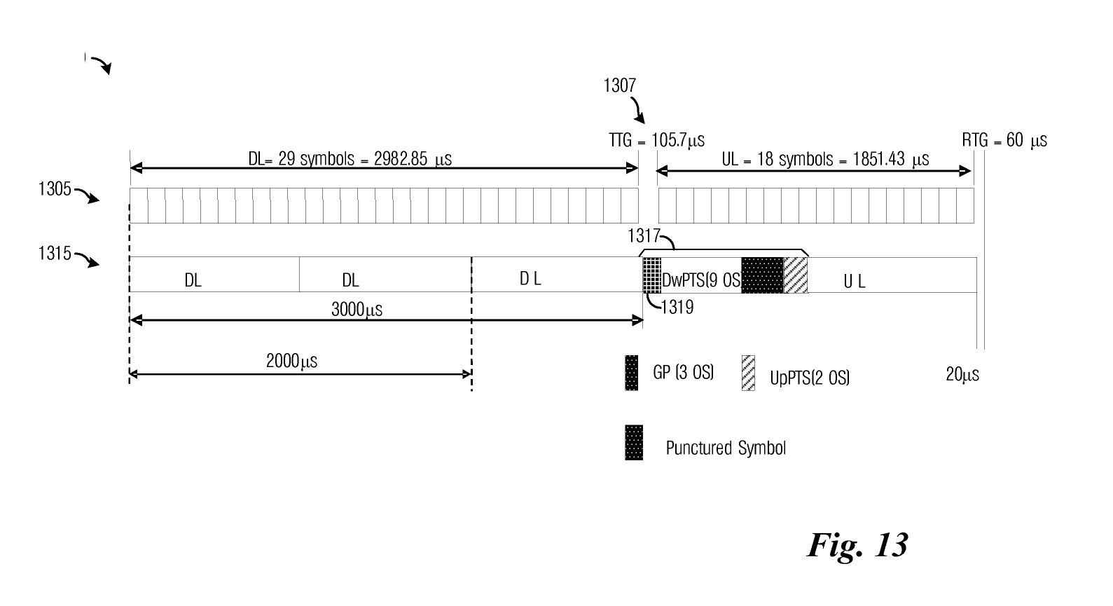

FIG. 13 illustrates a diagram 1300 of a frame structure 1305 of a WiMAX communications system and a frame structure 1315 of a 3GPP LTE TDD communications system with a portion of a special subframe punctured and with an alternate special subframe configuration in frame structure 1315. It is noted that frame structure 1315 is shifted to align with TTG 1307. As shown in FIG. 13, an alternate special subframe (with fields DwPTS, GP, and UpPTS of duration 9 OS, 3 OS, and 2 OS, respectively) is used to reduce interference to the WiMAX communications system. Clearly, other special subframe configurations are possible, depending on m, the amount of the shift, e.g., 2000 μs. The use of the different 3GPP LTE TDD frame configuration allows a puncturing of a portion of a DwPTS 1317 of the special subframe, shown as portion 1319. Depending on configuration of the special subframe, the punctured portion of DwPTS 1317 (i.e., portion 1319) may include the entirety of DwPTS 1317.

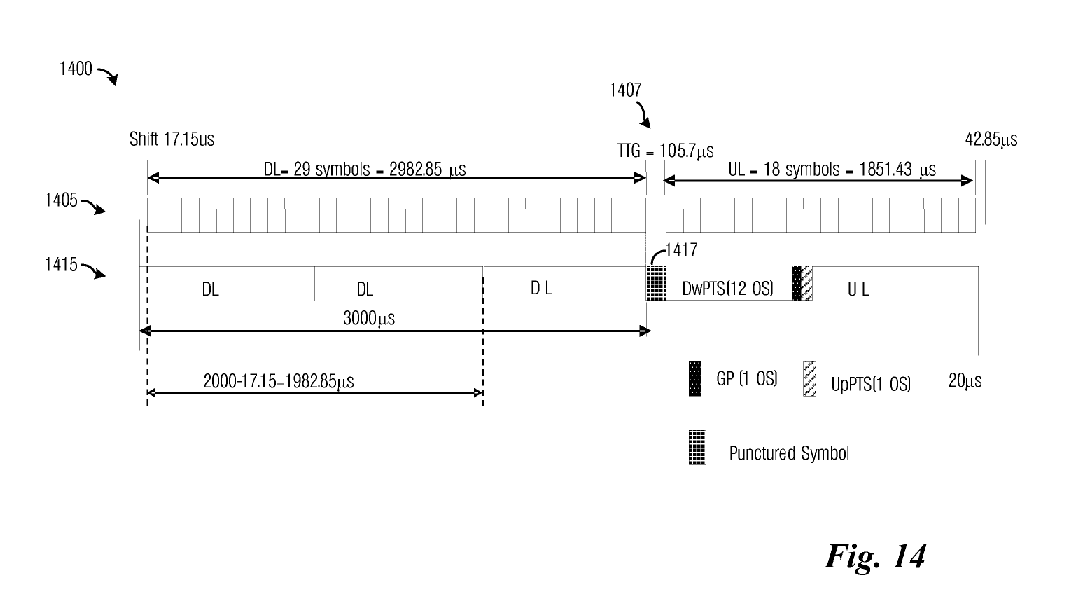

FIG. 14 illustrates a diagram 1400 of a frame structure 1405 of a WiMAX communications system and a frame structure 1415 of a 3GPP LTE TDD communications system with a portion of a special subframe punctured. Utilizing a shift that is equal to 2 3GPP LTE TDD subframe durations (i.e., 2000 μs) minus a value x that aligns a special subframe with TTG 1407, e.g., 17.15 μs, which makes the shift equal to 2000 μs−x or 1982.85 μs. Frame structure 1405 may be shifted back 1982.85 μs or frame structure 1415 may be shifted forward 1982.85 μs. A portion of DwPTS (shown as portion 1417) or the entirety of DwPTS may be punctured to avoid interference with TTG 1407.

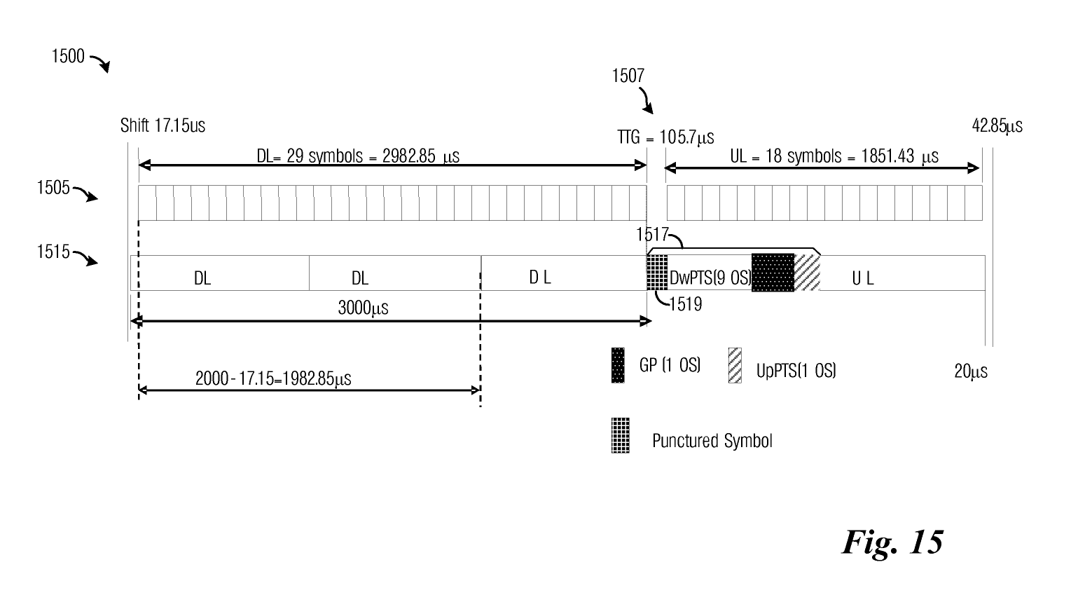

FIG. 15 illustrates a diagram 1500 of a frame structure 1505 of a WiMAX communications system and a frame structure 1515 of a 3GPP LTE TDD communications system with a portion of a special subframe punctured and with an alternate special subframe configuration in frame structure 1515. It is noted that frame structure 1515 is shifted to align with TTG 1507, e.g., by an amount that is equal to 2 3GPP LTE TDD subframe durations (i.e., 2000 μs) minus a value x in μs that aligns a special subframe with TTG 1407, e.g., 17.15 μs, which makes the shift equal to 2000 μs−x μs or 1982.85 μs. As shown in FIG. 15, an alternate special subframe (with fields DwPTS, GP, and UpPTS of duration 9 OS, 1 OS, and 1 OS, respectively) is used to reduce interference to the WiMAX communications system. Clearly, other special subframe configurations are possible, depending on m, the amount of the shift. The use of the different 3GPP LTE TDD frame configuration allows a puncturing of a portion of a DwPTS 1517 of the special subframe, shown as portion 1519. Depending on configuration of the special subframe, the punctured portion of DwPTS 1517 (i.e., portion 1519) may include the entirety of DwPTS 1517.

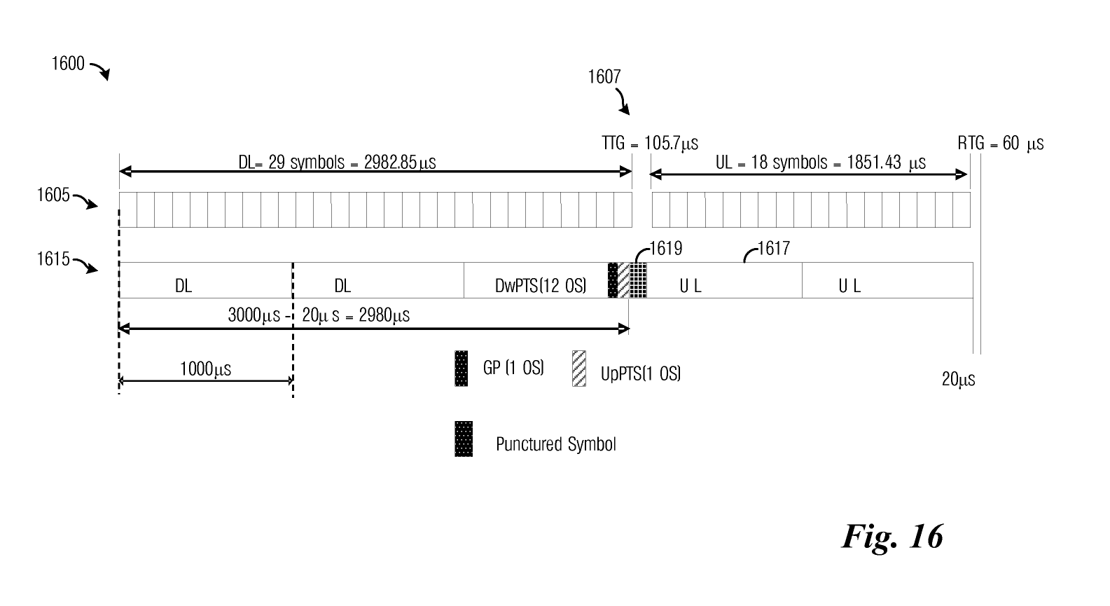

FIG. 16 illustrates a diagram 1600 of a frame structure 1605 of a WiMAX communications system and a frame structure 1615 of a 3GPP LTE TDD communications system with a portion of a UL subframe being punctured. As shown in FIG. 16, a portion of UL subframe 1617 (shown as portion 1619) immediately after UpPTS is punctured to prevent interference with TTG 1607.

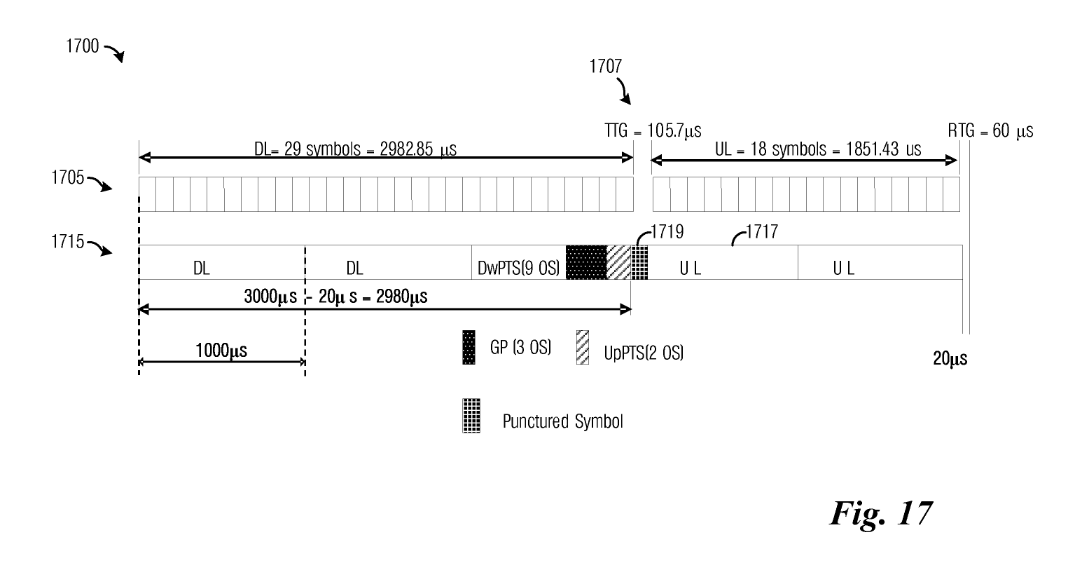

FIG. 17 illustrates a diagram 1700 of a frame structure 1705 of a WiMAX communications system and a frame structure 1715 of a 3GPP LTE TDD communications system with a portion of a UL subframe being punctured and an alternate special subframe structure. As shown in FIG. 17, a portion of UL subframe 1717 (shown as portion 1719) immediately after UpPTS is punctured to prevent interference with TTG 1707. As shown in FIG. 17, an alternate special subframe (with fields DwPTS, GP, and UpPTS of duration 9 OS, 3 OS, and 2 OS, respectively) is used.

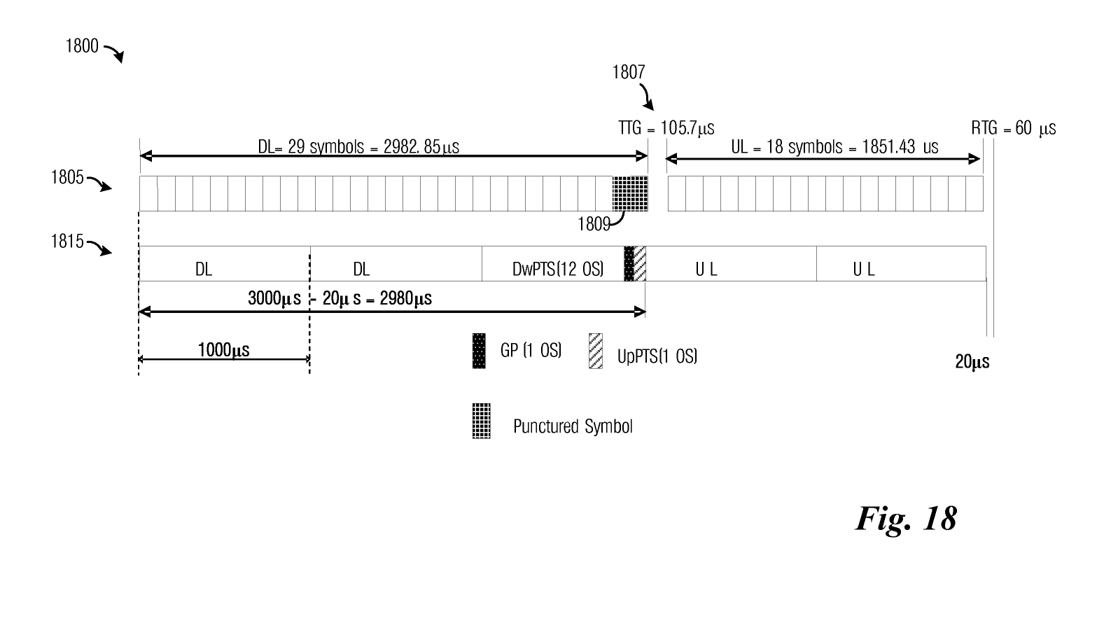

FIG. 18 illustrates a diagram 1800 of a frame structure 1805 of a WiMAX communications system and a frame structure 1815 of a 3GPP LTE TDD communications system with a portion of frame structure 1805 being punctured and frame structure 1815 is shifted. As shown in FIG. 18, a portion of the WiMAX DL subframe (shown as portion 1809 comprising multiple symbols) immediately preceding TTG 1807 is punctured. Additionally, frame structure 1815 is shifted by an amount z μs to align frame structure 1815 with TTG 1807 and portion 1809.

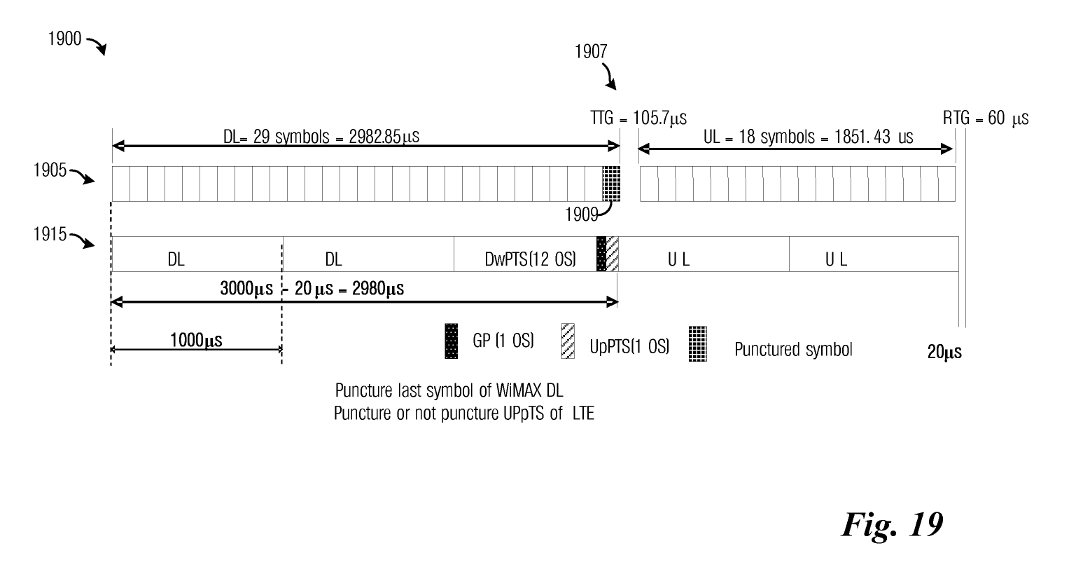

FIG. 19 illustrates a diagram 1900 of a frame structure 1905 of a WiMAX communications system and a frame structure 1915 of a 3GPP LTE TDD communications system with a portion of frame structure 1905 being punctured and frame structure 1915 is shifted. As shown in FIG. 19, a portion of the WiMAX DL subframe (shown as portion 1909 comprising a single symbol) immediately preceding TTG 1907 is punctured. Additionally, frame structure 1915 is shifted by an amount z μs to align frame structure 1915 (e.g., UpPTS) with TTG 1907 and portion 1909. In frame structure 1915, UpPTS may or may not be punctured.

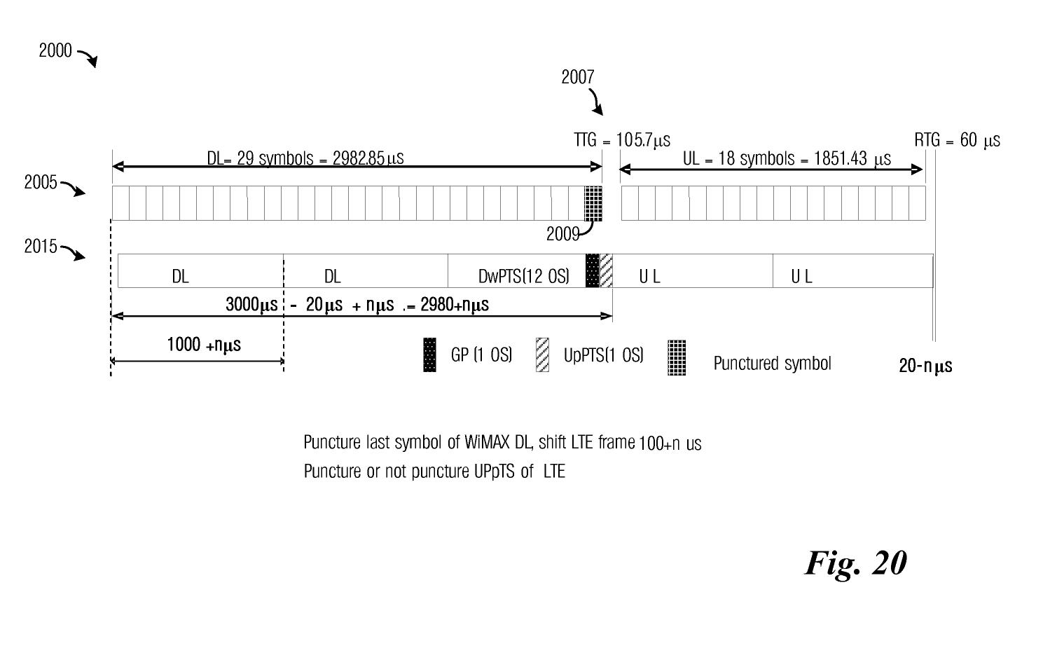

FIG. 20 illustrates a diagram 2000 of a frame structure 2005 of a WiMAX communications system and a frame structure 2015 of a 3GPP LTE TDD communications system with a portion of frame structure 2005 being punctured and frame structure 2015 is shifted. As shown in FIG. 20, a portion of the WiMAX DL subframe (shown as portion 2009 comprising a single symbol) immediately preceding TTG 2007 is punctured. Additionally, frame structure 2015 is shifted by an amount n μs to align frame structure 2015 (e.g., GP) with TTG 2007 and portion 2009. In frame structure 2015, UpPTS may or may not be punctured.

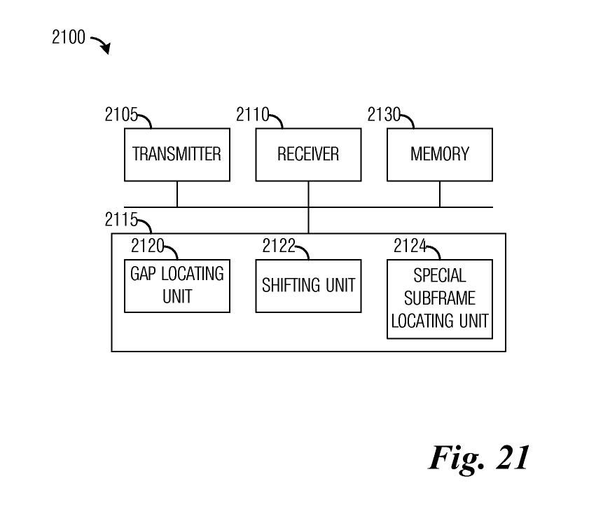

FIG. 21 illustrates a communications device 2100. Communications device 2100 may be an implementation of a communications controller in a communications system, such as an evolved NodeB, a base station, and the like. Communications device 2100 may be an implementation of a network entity that controls interactions between multiple coexisting communications systems, such as controller 135 of FIG. 1. Communications device 2100 may be used to implement various ones of the embodiments discussed herein. As shown in FIG. 21, a transmitter 2105 is configured to send packets and a receiver 2110 is configured to receive packets. Transmitter 2105 and receiver 2110 may have a wireless interface, a wireline interface, or a combination thereof.

A gap locating unit 2120 is configured to locate a gap, such as a TTG, in a first frame structure of a first communications protocol of a first communications system. A shifting unit 2122 is configured to shift a second frame structure of a second communications protocol of a second communications system to align the second frame structure with the gap. A special subframe locating unit 2124 is configured to locate a special subframe within the second frame structure, which is used to align the second frame structure with the gap of the first frame structure. A memory 2130 is configured to store locations of the gap and the special subframe, shifts applied to the first frame structure and/or the second frame structure, punctured portions of the first frame structure and/or the second frame structure, and the like.

The elements of communications device 2100 may be implemented as specific hardware logic blocks. In an alternative, the elements of communications device 2100 may be implemented as software executing in a processor, controller, application specific integrated circuit, and the like. In yet another alternative, the elements of communications device 2100 may be implemented as a combination of software and/or hardware.

As an example, transmitter 2105 and receiver 2110 may be implemented as a specific hardware block, while gap locating unit 2120, shifting unit 2122, and special subframe locating unit 2124 may be software modules executing in a processor 2115, a microprocessor, a custom circuit, or a custom compiled logic array of a field programmable logic array.

Although the present invention and its advantages have been described in detail, it should be understood that various changes, substitutions and alterations can be made herein without departing from the spirit and scope of the invention as defined by the appended claims.

What is claimed is:

1. A method for enabling a coexistence of multiple communications systems, the method comprising:
locating a gap in a first frame structure of a first communications protocol used in a first communications system;
shifting a second frame structure of a second communications protocol used in a second communications system into alignment with the gap to inhibit interference between simultaneous transmissions of the first communications system and the second communications system; and
transmitting the shifted second frame structure to a communications device in the second communications system.

2. The method of claim 1, further comprising puncturing a portion of the second frame structure.

3. The method of claim 2, wherein the punctured portion of the second frame structure comprises an overlapping portion of the second frame structure that corresponds to the gap in the first frame structure.

4. The method of claim 1, wherein the second frame structure is shifted by an amount ranging from an offset plus a difference in a length of the first frame structure to the offset plus a length of the second frame structure to a duration between successive frames in the second communications system.

5. The method of claim 4, wherein the second frame structure is shifted by an amount ranging from (1000+2.85) μs to (1000+20) μs, where 1000 is the offset.

6. The method of claim 1, wherein the second frame structure is shifted by an amount greater than a duration between successive frames in the second communications system, and wherein the method further comprises puncturing a portion of the second frame structure that will overlap with a successive frame in the first communications system.

7. The method of claim 1, wherein shifting the second frame structure comprises shifting the second frame structure so that a special subframe in the second frame structure is in alignment with the gap, and wherein the method further comprises puncturing a portion of the special subframe that overlaps with the gap of the first frame structure.

8. The method of claim 7, wherein the punctured portion of the special subframe is an uplink pilot time slot or a downlink pilot time slot.

9. The method of claim 1, further comprising puncturing a portion of the first frame structure adjacent to the gap.

10. The method of claim 1, wherein the first communications protocol is a WiMAX communications protocol.

11. The method of claim 1, wherein the second communications protocol is a Third Generation Partnership Project Long Term Evolution Time Division Duplex communications protocol.

12. A method for enabling a coexistence of multiple communications systems, the method comprising:
locating a first conflict region in a first frame structure of a first communications protocol used in a first communications system and a second conflict region in a second frame structure of a second communications protocol used in a second communications system, wherein a first simultaneous transmission by the first communications system in the first conflict region and a second simultaneous transmission by the second communications system in the second conflict region result in interference;
puncturing a subset of the first conflict region in the first frame structure, thereby producing a punctured first frame structure; and
transmitting the punctured first frame structure to a communications device in the first communications system.

13. The method of claim 12, wherein puncturing the subset of the first conflict region comprises blanking network resources corresponding to the subset of the first conflict region.

14. The method of claim 12, further comprising:
puncturing a subset of the second conflict region in the second frame structure, thereby producing a punctured second frame structure; and
transmitting the punctured second frame structure to a second communications device in the second communications system.

15. The method of claim 12, further comprising, prior to locating the conflict region:
locating a first feature in the first frame structure;
locating a second feature of the second frame structure; and
aligning the second feature with the first feature to inhibit interference between simultaneous transmissions of the first communications system and the second communications system, thereby producing an altered second frame structure.

16. The method of claim 15, wherein locating the first conflict region comprises locating the first conflict region in the first frame structure and the second conflict region in the altered second frame structure.

17. The method of claim 15, wherein the first feature comprises a gap, and wherein the second feature comprises a special subframe.

18. The method of claim 15, wherein the first feature comprises a special subframe, and wherein the second feature comprises a gap.

19. The method of claim 15, wherein aligning the second feature comprises shifting the second frame structure.

20. The method of claim 15, wherein aligning the second feature comprises aligning a leading edge of the second feature with a leading edge of the first feature.

21. The method of claim 15, wherein aligning the second feature comprises aligning a trailing edge of the second feature with a trailing edge of the first feature.

22. A device comprising:
a processor configured to locate a gap in a first frame structure of a first communications protocol used in a first communications system, and to shift a second frame structure of a second communications protocol used in a second communications system into alignment with the gap to inhibit interference between simultaneous transmissions of the first communications system and the second communications system; and
a transmitter coupled to the processor, the transmitter configured to transmit the shifted second frame structure to a communications device in the second communications system.

23. The device of claim 22, wherein the transmitter is configured to transmit the shifted second frame structure to the communications device upon the communications device attaching to the second communications system.

24. The device of claim 23, further comprising a memory configured to store the shifted second frame structure.

25. The device of claim 22, wherein the processor is configured to locate the gap and to shift the second frame structure while the first communications system and the second communications system are in operation, and wherein shifted second frame structure is transmitted to the communications device after the second frame structure is shifted.

26. The device of claim 22, wherein the processor is configured to puncture a portion of the second frame structure that overlaps with the gap of the first frame structure.

27. The device of claim 22, wherein the processor is configured to shift the second frame structure so that a special subframe in the second frame structure is in alignment with the gap.

28. The device of claim 22, wherein the first communications system is a WiMAX compliant communications system.

29. The device of claim 22, wherein the second communications protocol is a Third Generation Partnership Project Long Term Evolution Time Division Duplex compliant communications system.
